(19) United States
(12) Patent Application Publication
(10) Pub. No.: US 2016/0195093 A1
(43) Pub. Date: Jul. 7, 2016

(54) FLOW MONITORING DEVICE FOR HYDRAULIC PUMP

(71) Applicant: Caterpillar Inc., Peoria, IL (US)

(72) Inventors: Richard A. Carpenter, Chillicothe, IL (US); Peter Dubenco, Chicago, IL (US); Stephen J. Morey, Peoria, IL (US)

(73) Assignee: Caterpillar Inc., Peoria, IL (US)

(21) Appl. No.: 15/067,191

(22) Filed: Mar. 11, 2016

(51) Int. Cl. F04D 15/00; G01F 1/68; G01F 1/36

(52) U.S. Cl. CPC F04D 15/0083; G01F 1/363; G01F 1/68

(57) ABSTRACT

A flow monitoring device is coupled to a case drain of a hydraulic pump. The flow monitoring device includes a manifold to receive a fluid flow from the case drain. The manifold has an inlet, a throat and an outlet. The manifold includes a pressure sensor to measure a differential pressure of fluid between the inlet and the throat. The manifold further includes a temperature sensor to measure a temperature of fluid flowing through the manifold. A bypass passage is fluidly coupled between the inlet and the outlet of the manifold. A bypass valve located in the bypass passage regulates an amount of fluid flowing from the inlet to the outlet of the manifold through the bypass passage.

### TECHNICAL FIELD

The present disclosure generally relates to a flow monitoring device of a hydraulic pump. More particularly, the present disclosure relates to the flow monitoring device for monitoring a health of the hydraulic pump.

### BACKGROUND

Work machines such as hydraulic excavators include hydraulic systems for running motors or extending and retracting cylinders. These hydraulic systems include pumps having rotating groups that may wear over time and eventually fail. If the failure of a pump is catastrophic, substantial debris may be introduced into the hydraulic system that may cause damage to other components.

As a pump begins to wear, volumetric inefficiencies increases. In an axial piston type pump having an external case drain, these inefficiencies are typified by fluid leaks around a face of the slipper, a ball socket, a piston wall, a port plate barrel interface, and a displacement control device. The leaking fluid then exits the hydraulic pump through the external case drain. By sensing the flow of fluid through the case drain, an indication of the extent of leakage may be obtained.

Many conventional flow meters, such as turbine or paddle wheel flow sensors, may cause substantial back pressure. This back pressure on the pump case causes a pressure differential between an outlet and an inlet of the pump which tends to pull the slipper away from the piston. In addition, shaft seals can be damaged by excess back pressure. Furthermore, pump displacement controls designed to drain to the case may suffer deleterious effects from high back pressure. Such flow meters causing significant back pressure may cause a premature destruction of the pump or difficulty in pump displacement control.

U.S. Pat. No. 8,437,922 discloses a method that measures multiple pressure drops across an orifice in case drain line of a hydraulic pump and determines corresponding actual flow rates. An estimation of flow rates is also made based on operating parameters. A difference in the actual and estimated flow rates provides an account for any inconsistencies and impending failures. However, the case drain flow passing through the orifice creates backpressure on the pump which is undesirable for pump operation and may itself be a cause of pump failure. Also, the pressure drops are measured at discrete intervals which may not provide substantial data points to establish a trend of uncharacteristically high pressures in the case drain flow.

Thus, there is a need for an improved flow monitoring device to measure a flow rate of fluid from a case drain of the hydraulic pump while minimizing the back pressure on the hydraulic pump.

### SUMMARY OF THE DISCLOSURE

In an aspect of the present disclosure, a flow monitoring device is provided. The flow monitoring device is coupled to a case drain of a hydraulic pump. The flow monitoring device includes a manifold to receive a flow of fluid from the case drain of the hydraulic pump. The manifold has an inlet, a throat and an outlet. The manifold further includes a pressure sensor to provide a signal indicative of differential pressure between the inlet and the throat. The manifold also includes a temperature sensor disposed in the manifold to measure a temperature of the fluid flowing through the manifold. Further, a bypass passage is coupled between the inlet and the outlet of the manifold. The bypass passage includes a bypass valve to regulate an amount of fluid flowing through the bypass passage from the inlet of the manifold.

### BRIEF DESCRIPTION OF THE DRAWINGS

FIG. 1 is a schematic of a system for monitoring health of a hydraulic pump in accordance with an embodiment of the present disclosure; and

FIG. 2 is a perspective view of a flow monitoring device in accordance with an embodiment of the present disclosure; and

FIG. 3 is a cross sectional view of the flow monitoring device shown in FIG. 2 in accordance with an embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

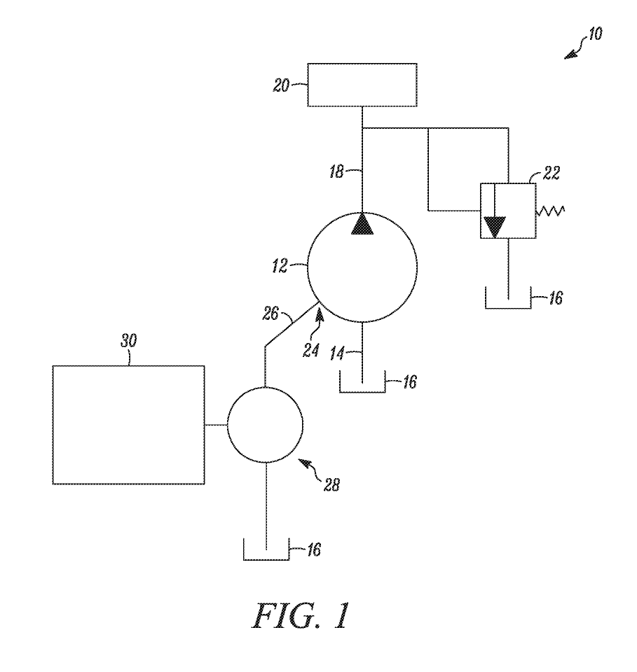

Referring to FIG. 1, a system 10 is illustrated for monitoring health of a hydraulic pump 12. The hydraulic pump 12, for example an axial piston pump, has an inlet line 14 connected to a hydraulic tank 16 and a main discharge line 18. The main discharge line 18 is connected to a group of valves 20 that direct pressurized hydraulic fluid to implements selected by an operator. The main discharge line 18 is also connected to a relief valve 22. The hydraulic pump 12 also includes a case drain 24 that provides a passage for fluid to flow from a pump case to the hydraulic tank 16. The flow of fluid from the case drain 24 is utilized to determine a health of the hydraulic pump 12. In this regard, a flow monitoring device 28 is connected to the case drain 24 to measure a temperature, and a pressure of the fluid flow passing from the hydraulic pump 12 back to the hydraulic tank 16 through a case drain line 26. The flow monitoring device 28 is further connected to a controller 30 that determines a flow rate of the fluid received from the case drain 24 based on the temperature and the pressure of the fluid measured by the flow monitoring device 28.

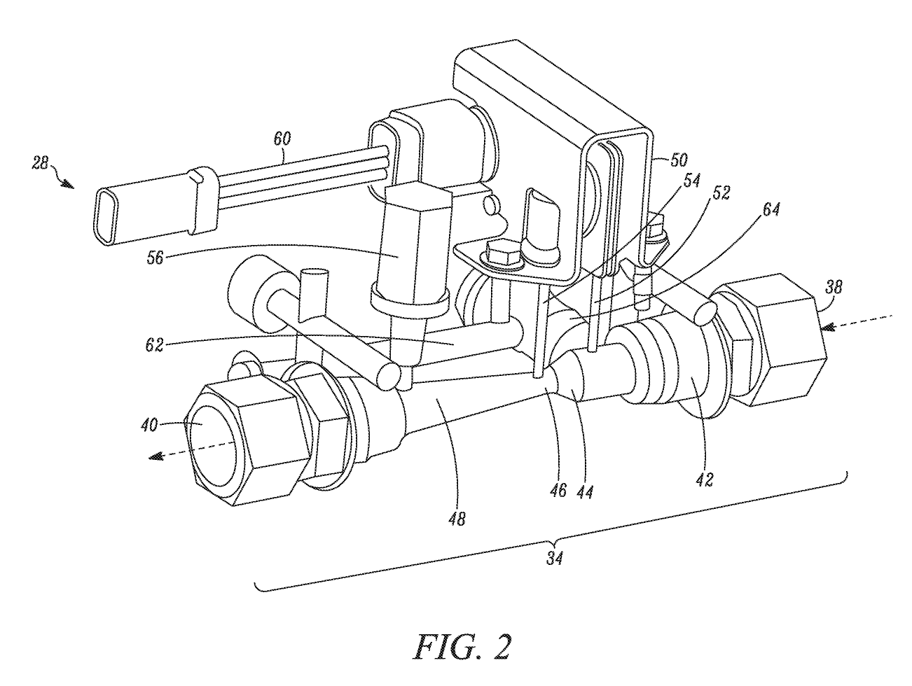

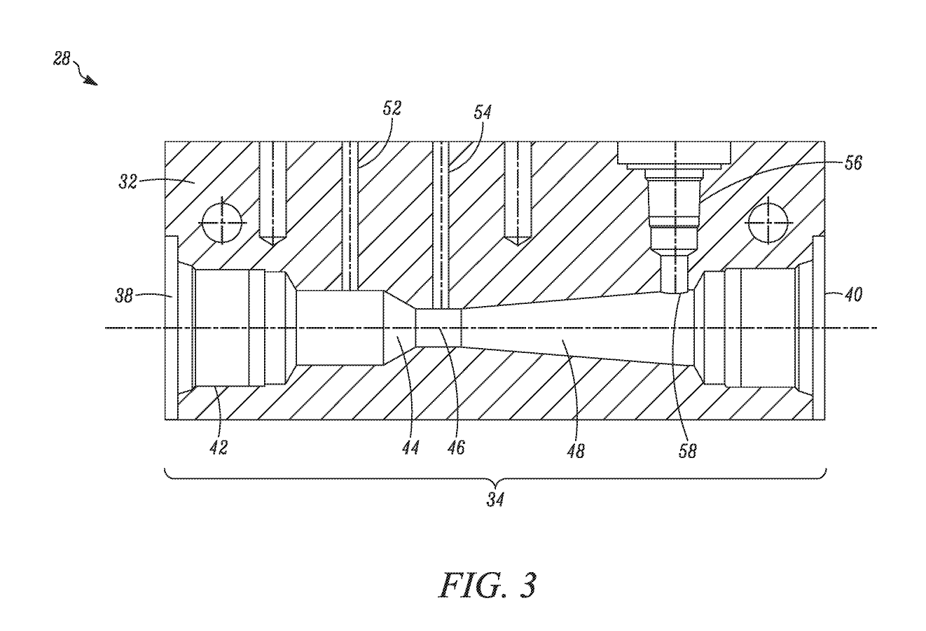

Referring to FIGS. 2 to 3, the flow monitoring device 28 is illustrated. The flow monitoring device 28 includes a housing 32 (shown in FIG. 3) encapsulating a manifold 34. For simplification and showing the internal components, the housing 32 is hidden in FIG. 2. The manifold 34 defines a fluid path as depicted by arrows in FIG. 2. The manifold 34 includes an inlet 38 configured for fluid connection to the case drain 24 and an outlet 40 that drains fluid to the hydraulic tank 16. As shown, the inlet 38 and outlet 40 may have female threaded connections and may, therefore, each be configured to receive a male threaded connection. However, it will be appreciated that the inlet 38 and the outlet 40 may include other means for connection to the case drain 24.

The fluid path of the manifold 34 begins with the inlet 38 having a cylindrical geometry 42 followed by a convergent portion 44 to form a throat 46. Subsequently, the fluid path has a divergent geometry 48 to form the outlet 40. The specific geometry of the manifold 34 is utilized to determine a pressure differential of the flow of fluid between the inlet 38 and the throat 46, which may be used to calculate a flow rate of the fluid based on the pressure differential and the area of an inlet and an outlet of the convergent portion 44.

As shown in FIG. 2, a differential pressure sensor 50 is operatively connected to the manifold 34, tapping the pressure of the fluid at the inlet 38 through a first pressure port 52 and at the throat 46 of the manifold 34 through a second pressure port 54. The differential pressure sensor 50 is communicably coupled to the controller 30 to provide the differential pressure reading based on the pressure obtained at the inlet 38 and the throat 40. Though, the differential pressure sensor 50 is shown in FIGS. 2 and 3, in various other embodiments, there may be separate pressure sensors located at both the inlet 38 and the throat 40, and are communicably coupled to the controller 30. In such an embodiment, the controller 30 is configured to determine a pressure differential based on the readings obtained from the separate sensors.

The flow monitoring device 28 further includes a temperature sensor 56 operatively connected to the manifold 34. In one embodiment, the temperature sensor 56 may be a thermistor which outputs a signal representative of the temperature of the fluid. As shown in FIGS. 2 and 3, the temperature sensor 56 is disposed in a bore 58 intersecting the fluid path in the manifold 34. It will be appreciated that the temperature of the fluid may be measured without direct contact between the temperature sensor 56 and the fluid. For example, the fluid may contact a stainless steel shell residing in the bore 58, the temperature sensor 56 measuring the temperature of the stainless steel shell as being representative of the temperature of fluid. Though the FIGS. 2 and 3 show the temperature sensor 56 to be located downstream of the throat 46 and near the divergent geometry 48, in various other embodiments, the temperature sensor 56 may be located at any other location in the fluid path of the manifold 34. The temperature sensor 56 is communicably coupled to the controller 30 to provide a signal indicative of the temperature of the fluid flowing through the fluid path.

The controller 30 receives signals from the differential pressure sensor 50 and the temperature sensor 56 via communication cables 60. The controller 30 subsequently measures the flow rate of the fluid based on the readings of the differential pressure across the flow monitoring device 28. The controller 30 may further determine if the measured flow rate is within a predetermined threshold value of the allowed flow rate at a particular temperature of the fluid. In an embodiment, the controller 30 may use look up tables for determining whether the flow rate is within predetermined threshold based on a particular temperature of the fluid. In various embodiments, if the measured flow rate exceeds a predetermined threshold for the flow rate, the controller 30 may provide a visual or tactile indication that the measured flow rate exceeds the predetermined threshold value. By this measurement and indication, the controller 30 is configured to notify an operator that the hydraulic pump 12 may require maintenance to avoid failure.

Referring to FIG. 2, the flow monitoring device 28 also includes a bypass passage 62 connected downstream of the case drain 24. The bypass passage 62 provides an alternative fluid path by fluidly connecting the inlet 38 of the manifold 34 to the outlet 40 of the manifold 34. The bypass passage 62 includes a bypass valve 64 that regulates an amount of fluid that directs away from the fluid path of the manifold 34 and flows through the bypass passage 62 to the outlet 40 of the manifold 34. In an embodiment, the bypass valve 64 is operated by the controller 30 based on the measured flow rate of the fluid at a specific temperature, to avoid a back pressure on the hydraulic pump 12. In another embodiment, the bypass valve 64 is self-calibrated to bypass a predetermined flow of fluid through the bypass passage 62 if the flow rate on the inlet side of the bypass valve 64 exceeds above a pre-determined threshold.

### INDUSTRIAL APPLICABILITY

Flow through the case drain 24 of hydraulic pump 12 increases when the hydraulic pump 12 wears. At some threshold level, the hydraulic pump 12 is considered worn out and replacement should proceed at the next available servicing. Similarly, if the magnitude of flow is increasing at a substantial rate, this could indicate an impending catastrophic failure. The flow monitoring device 28, of the present disclosure provides a means to measure the flow rate of the fluid from the case drain 24 and in turn monitors the health of the hydraulic pump 12.

The flow monitoring device 28 is communicably connected to the controller 30. The flow monitoring device 28 determines a differential pressure of fluid flowing through the fluid path, which enables the controller 30 to measure the flow rate based on the differential pressure and the geometry of the manifold. Further, the flow monitoring device 28 also determines a temperature of the fluid received from the case drain 24.

The controller 30 may subsequently determine if the measured flow rate is within a predetermined threshold value of the allowed flow rate at a particular temperature of the fluid. If the measured flow rate exceeds a predetermined threshold for the flow rate, the controller may provide an alarm and thus provides an opportunity to avoid catastrophic failure of the hydraulic pump 12.

Further, the flow monitoring device 28, of the present disclosure also minimizes backpressure on the hydraulic pump 12. The flow monitoring device 28 includes the bypass passage 62 and the bypass valve 64. The bypass valve 64 may be operated by the controller 30 to divert a portion of the flow of fluid from the fluid path and to pass through the bypass passage 62 when the flow rate of the fluid is above a pre-determined threshold at a particular temperature of the fluid.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A flow monitoring device coupled to a hydraulic pump, the flow monitoring device comprising:
a manifold configured to receive a flow of fluid from a case drain of the hydraulic pump, the manifold having an inlet, a throat and an outlet;
a pressure sensor coupled with the manifold, wherein the pressure sensor is configured to provide a signal indicative of a pressure difference between the inlet and the throat of the manifold;
a temperature sensor disposed in the manifold, wherein the temperature sensor is configured to provide a signal indicative of a temperature of the fluid;
a bypass passage fluidly coupled between the inlet and the outlet of the manifold; and
a bypass valve disposed in the bypass passage, wherein the bypass valve regulates an amount of fluid flowing through the bypass passage from the inlet of the manifold.
